(19) United States
(12) Patent Application Publication
(10) Pub. No.: US 2018/0343132 A1
(43) Pub. Date: Nov. 29, 2018

(54) ENHANCED RESOURCE SHARING FOR PRS MEASUREMENTS

(71) Applicant: QUALCOMM Inc., San Diego, CA (US)

(72) Inventors: Ankit Maheshwari, Hyderabad (IN); Guttorm Opshaug, Redwood City, CA (US); Jie Wu, San Diego, CA (US); Atul Soni, Hyderabad (IN); Shruti Agrawal, Hyderabad (IN)

(21) Appl. No.: 15/631,573

(22) Filed: Jun. 23, 2017

Related U.S. Application Data
(60) Provisional application No. 62/511,139, filed on May 25, 2017.

(51) Int. Cl. H04L 12/16; H04L 12/64

(52) U.S. Cl. CPC H04L 12/16; H04L 12/189; H04L 12/6418

(57) ABSTRACT

Example methods, apparatuses, and/or articles of manufacture are disclosed herein that may be utilized, in whole or in part, to facilitate and/or support one or more operations and/or techniques for enhanced resource sharing for positioning reference signals (PRS) measurements, such as for use in or with mobile communication devices, for example.

### CROSS-REFERENCE TO RELATED APPLICATIONS

This patent application claims the benefit of and priority to pending U.S. Provisional Patent Application No. 62/511,139, filed May 5, 2017, entitled “ENHANCED RESOURCE SHARING FOR PRS MEASUREMENTS,” which is assigned to the assignee hereof and which is expressly incorporated herein by reference.

### BACKGROUND

### 1. Field

The present disclosure relates generally to position or location estimations of communication devices and, more particularly, to enhanced resource sharing for positioning reference signal (PRS) measurements, such as for use in or with mobile communication devices.

### 2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or like smart communication devices may be capable of estimating their geographic locations via positioning assistance parameters obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless or electronic communications network. Acquired wireless signals may, for example, be processed by or at a mobile communication device, and its location may be estimated using known techniques, such as Advanced Forward Link Trilateration (AFLT), base station identification, cell tower triangulation, or the like.

In an indoor or like environment, such as urban canyons, for example, certain mobile communication devices may be unable to reliably receive or acquire satellite or like wireless signals to facilitate and/or support one or more position estimation techniques. For example, signals from an SPS or other wireless transmitters may be attenuated or otherwise affected in some manner (e.g., insufficient, weak, fragmentary, etc.), which may at least partially preclude their use for position estimations. At times, a mobile communication device may obtain a position fix by measuring ranges to three or more terrestrial wireless transmitter devices, such as cellular base stations, access points, etc. positioned at known locations. Ranges may be measured, for example, by obtaining a Media Access Control identifier (MAC ID) address from wireless signals received from suitable access points and measuring one or more characteristics of received signals, such as signal strength, round trip delay, or the like.

In some instances, a position fix of a mobile communication device may be obtained in connection with an observed time difference of arrival (OTDOA) technique. In this technique, a mobile communication device may measure timing differences between reference signals received from two or more pairs of cellular base stations, for example, and may obtain a position fix based, at least in part, on known locations and transmission timing for the measured base stations. At times, an OTDOA positioning technique may, for example, also be employed to assist in localization of a mobile communication device in the event of an emergency call, such as in compliance with Emergency 911 (E911) mandates from the Federal Communication Commission (FCC).

Increasingly, OTDOA measurements may be obtained and/or supported via positioning operations for a number of smaller and/or lower-power mobile communication devices leveraging existing Internet or like infrastructure as part of the so-called “Internet of Things” or IoT, such as via a variety of protocols, domains, and/or applications. The IoT is typically a system of interconnected and/or internetworked physical devices in which computing is embedded into hardware so as to facilitate and/or support devices' ability to acquire, collect, and/or communicate data over one or more communications networks, for example, at times, without human participation and/or interaction. IoT devices may include a wide variety of embedded devices, such as, for example, automobile sensors, biochip transponders, heart monitoring implants, kitchen appliances, locks or like fastening devices, solar panel arrays, home gateways, smart gauges, smart telephones, or the like capable of being identified (e.g., uniquely, via an assigned Internet Protocol (IP) address, etc.) and/or having the ability to communicate data over one or more communications networks. At times, however, performing measurements of reference signals in connection with OTDOA positioning may increase power consumption of certain mobile communication devices with limited power resources, such as lower-power, resource-constrained, etc. embedded devices (e.g., battery-operated, etc.), for example, thus, negatively affecting operating lifetime and/or overall utility of these or like devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process for enhanced resource sharing for PRS measurements.

FIG. 3 is a flow diagram illustrating another implementation of an example process for enhanced resource sharing for PRS measurements.

FIG. 4 is a schematic diagram illustrating an implementation of an example computing environment associated with a mobile device.

FIG. 5 is a schematic diagram illustrating an implementation of an example computing environment associated with a server.

### SUMMARY

Example implementations relate to techniques for enhanced resource sharing for positioning reference signals (PRS) measurements. In one implementation, a method, at a mobile device, may comprise configuring a transceiver device, the transceiver device comprising a transmitter and a receiver, to operate in a half-duplex mode for communication of messages between the mobile device and an access transceiver device; and selectively configuring the receiver to acquire positioning occasions of a positioning reference signal (PRS) while the transmitter is transmitting messages to the access transceiver device and while the transceiver device is operating in the half-duplex mode

In another implementation, an apparatus may comprise means for configuring a transceiver device, the transceiver device comprising a transmitter and a receiver, to operate in a half-duplex mode for communication of messages between a mobile device and an access transceiver device; and means for selectively configuring the receiver to acquire positioning occasions of a positioning reference signal (PRS) while the transmitter is transmitting messages to the access transceiver device and while the transceiver device is operating in the half-duplex mode.

In yet another implementation, an apparatus may comprise a communication interface coupled to a receiver of a mobile device to communicate with an electronic communications network and one or more processors coupled to a memory and to the communication interface, the communication interface and the one or more processors configured to configure a transceiver device, the transceiver device comprising a transmitter and a receiver, to operate in a half-duplex mode for communication of messages between the mobile device and an access transceiver device; and selectively configure the receiver to acquire positioning occasions of a positioning reference signal (PRS) while the transmitter is transmitting messages to the access transceiver device and while the transceiver device is operating in the half-duplex mode.

In yet another implementation, an article may comprise a non-transitory storage medium having instructions executable by a processor to configure a transceiver device, the transceiver device comprising a transmitter and a receiver, to operate in a half-duplex mode for communication of messages between a mobile device and an access transceiver device; and selectively configure the receiver to acquire positioning occasions of a positioning reference signal (PRS) while the transmitter is transmitting messages to the access transceiver device and while the transceiver device is operating in the half-duplex mode.

In yet another implementation, a method, at a mobile device, may comprise allocating repetitions of a receiver for acquisition of one or more symbols transmitting in a downlink signal; and re-allocating remaining repetitions of receiver for acquisition of positioning reference signal (PRS) positioning occasions in response to a successful decoding of the one or more symbols from the downlink communication channel. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, and/or articles of manufacture are disclosed herein that may be implemented, in whole or in part, to facilitate and/or support one or more operations and/or techniques for enhanced resource sharing for PRS measurements, such as for use in or with mobile communication devices. As used herein, “mobile communication device,” “location-aware mobile device,” or like terms may be used interchangeably and refer to any kind of special purpose computing platform and/or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heat map generation tools, IoT devices, or the like. It should be appreciated, however, that these are merely examples of mobile devices that may be used, at least in part, to implement one or more operations and/or techniques for enhanced resource sharing for PRS measurements, and that claimed subject matter is not limited in this regard. It should also be noted that the terms “position” and “location” may be used interchangeably herein.

As alluded to previously, in some instances, a mobile device may comprise, for example, a smaller and/or lower-power device capable of leveraging existing Internet or like infrastructure as part of the “Internet of Things” or IoT, such as via a variety of protocols, domains, and/or applications. For example, Release 13 of the 3rd Generation Partnership Project (3GPP) standard introduced a suite of narrowband IoT technologies capable of more efficiently and/or more effectively supporting lower data-rate applications, such as while coexisting with currently deployed Long Term Evolution (LTE) Advanced infrastructure, spectrum, and/or devices. As one example, a particular narrowband technology in Release 13 included an enhanced machine-type communication (eMTC) category M1 (Cat-M1) device. Typically, a Cat-M1 device comprises a receiver capable of processing LTE or like signals, and, in particular, PRS or like signals, such as to facilitate and/or support one or more positioning operations in connection with an OTDOA or like positioning technique. Particular examples of PRS will be discussed in greater detail below.

Continuing with the above discussion, typically, a Cat-M1 device employs a narrowband receiver of about 1.4 MHz, for example, but may operate within an LTE carrier environment of up to a 20 MHz operational bandwidth. As such, Cat-M1 devices may, for example, be deployed in existing LTE Advanced infrastructure and/or spectrum, as was indicated, and, thus, may more efficiently and/or more effectively coexist with in-use mobile broadband services. For example, at times, Cat-M1 devices may leverage legacy LTE synchronization signals (e.g. primary, secondary, etc.), while introducing new control and/or data channels that may be more efficient and/or more effective for lower bandwidth operations. As such, an LTE or like network supporting Cat-M1 devices may, for example, advantageously utilize multiple narrowband regions with frequency retuning, such as to enable scalable resource allocation, frequency hopping for diversity across an entire LTE band, or the like. It should be noted, however, that these are merely examples relating a particular mobile device, network, technology, etc., and that claimed subject matter is not so limited. For example, in some instances, a narrowband IoT (NB-IoT) device, such as utilizing 200 kHz bandwidth in LTE, as one possible example, may also be utilized herein, in whole or in part, such as in a similar or like fashion and/or without deviating from the scope of claimed subject matter.

At times, OTDOA or like positioning for these or like mobile devices may, for example, be implemented in connection with a location server via an exchange of messages, though claimed subject matter is not so limited. In some instances, messages may include one or more communication sequences regarding capability exchange and/or transfer, assistance data exchange and/or transfer, location information transfer, etc., or any combination thereof. As a way of illustration, at times, an OTDOA or like positioning session may include, for example, a session employing LTE or like technology (e.g., LTE Advanced, etc.), session providing one or more extensions for OTDOA or like positioning, such as an LTE positioning protocol (LPP) LPPe positioning session, though, again, claimed subject matter is not so limited. It should be noted that even though the discussion throughout the specification primarily references particular signals, protocols, and/or networks, such as, for example, PRS for OTDOA in LTE, such as for ease of description, any other suitable signals, protocols, and/or networks, such as 1x signals for Advanced Forward Link Trilateration (AFLT) in Code Division Multiple Access (CDMA), enhanced Cell ID (E-CID), and/or Wi-Fi positioning (e.g., based on downlink signals according to IEEE 802.11x standards, etc.), positioning for short range nodes (SRNs), such as Bluetooth® Low Energy (BTLE) beacons, satellite positioning system (SPS) signals, or the like may also be utilized herein, in whole or in part, such as in a similar or like fashion and/or without deviating from the scope of claimed subject matter.

Thus, as was also indicated, in some instances, a position fix of a mobile device, which may include an IoT device, such as an eMTC Cat-M1 device, for example, may be obtained based, at least in part, on information gathered from an OTDOA positioning system. In this system, a server may facilitate and/or support positioning of a mobile device by providing positioning assistance data as well as computing and/or verifying (e.g., if computed at a mobile device, etc.) a position fix using one or more specific signals, referred to as reference signals. Namely, a mobile device may, for example, measure a time difference between reference signals received from a reference wireless transmitter and one or more neighbor wireless transmitters positioned at known locations. In this context, a “wireless transmitter” refers to any suitable device capable of transmitting and/or receiving wireless signals, such as via an integrated or associated receiver and/or transmitter, for example. As a way of illustration, a wireless transmitter may comprise, for example, a cellular base station, wireless local area network (WLAN) access point, radio beacon, femtocell, picocell, access transceiver device, or the like. A mobile device may then compute its position fix, such as using obtained measurements or, optionally or alternatively, may report these measurements to a suitable location server, such as, for example, an Enhanced Serving Mobile Location Center (E-SMLC), a Secure User Plane Location (SUPL) Location Platform (SLP), or the like. In turn, with knowledge of locations of measured wireless transmitters, an E-SMLC, SUPL, or like server may, for example, compute a position fix of a mobile device using measured time differences and relative transmission timing, such as via one or more appropriate multilateration techniques, and may communicate the computed position fix to a mobile device of interest.

As was also indicated, at times, one or more operations and/or techniques for enhanced resource sharing for PRS measurements may also be implemented, at least in part, in connection with one or more other positioning approaches, such as those utilizing measurements of time differences of signals received from a number of wireless transmitters, for example. Thus, in some instances, one or more operations and/or techniques discussed herein may be utilized, at least in part, in connection with, for example, AFLT used for locating a mobile device on a CDMA2000 network, as defined by the 3rd Generation Partnership Project 2 (3GPP2). Similarly to OTDOA, AFLT positioning may, for example, make use of information for measured wireless transmitters to help a mobile device to acquire and/or measure applicable reference signals for purposes of computing a position fix based, at least in part, on these measurements. Depending on an implementation, information may include, for example, locations (e.g., coordinates, etc.), transmission characteristics (e.g., timing, power, signal content, signal characteristics, etc.) of measured wireless transmitters, such as referred to as an almanac, a base station almanac (BSA), almanac data or BSA data, etc. Thus, at times, observed time differences measured by a mobile device (e.g., in connection with OTDOA, AFLT, etc.) may, for example, be used, at least in part, in conjunction with a BSA for measured wireless transmitters to calculate a position fix of a mobile device, such as at or by a location server (e.g., an E-SMLC, SLP, etc.), mobile device, or any combination thereof.

Continuing with the above discussion, typically, to facilitate and/or support one or more operations and/or techniques for enhanced resource sharing for PRS measurements, one or more wireless transmitters on a network may broadcast a PRS that may be distinct from one or more PRS broadcasted by other nearby wireless transmitters due, at least in part, to a use of a different frequency, different encoding, different times of transmission, or the like. A mobile device may measure PRS transmitted by a reference wireless transmitter and a nearby wireless transmitter and may obtain, for example, a time of arrival (TOA) and/or a reference signal time difference (RSTD) measurement. In this context, “RSTD” refers to one or more measurements indicative of a difference in time of arrival between a PRS transmitted by a measured wireless transmitter, referred to herein as a “neighbor wireless transmitter,” and a PRS transmitted by a reference wireless transmitter. A reference wireless transmitter may be selected by a location server (e.g., an E-SMLC, SLP, etc.), mobile device, or a combination thereof so as to provide good or otherwise sufficient signal strength observed at a receiver of the mobile device so that a PRS can be more accurately and/or more quickly acquired and/or measured, such as without any special assistance from a serving network, for example.

At times, such as during an LTE Positioning Protocol (LPP) session, as one possible example, a mobile device may be provided with positioning assistance data by a serving network (e.g., by a location server, etc.) to assist in a PRS acquisition and/or measurement, as was also indicated. For example, at times, a location server may provide to a mobile device of interest OTDOA assistance data listing one or more neighbor wireless transmitters capable of transmitting a PRS, which may include identities, center frequencies, etc. of wireless transmitters, their expected RSTD, expected RSTD uncertainty, or the like. Assistance data may also include, for example, an identity of a reference wireless transmitter, frequency for a reference PRS signal, reference PRS code sequence, reference PRS transmission times, PRS configuration, or the like. For example, in some instances, a PRS configuration may comprise one or more parameters, such as PRS bandwidth, PRS subframe offset for a start of applicable PRS occasions, PRS configuration index, number of consecutive subframes, PRS muting pattern, etc. In some instances, assistance data may also specify one or more Quality of Service (QoS) parameters, which may also be used, at least in part, in connection with searching a PRS and/or measuring RSTD. For example, in some instances, a QoS parameter may comprise a response time for measuring TOA and/or providing RSTD measurements to a location server and which a mobile device and/or server may take into account, such as during an OTDOA or like positioning session, as one possible example.

A mobile device may then typically measure a PRS (e.g., a TOA for a PRS, etc.) for one or more neighbor wireless transmitters, such as by integrating a received signal at a neighbor wireless transmitter carrier frequency, for example, in accordance with provided assistance data (e.g., a PRS configuration, etc.) and a QoS parameter (e.g., a maximum response time, etc.). For example, based, at least in part, on received assistance data and/or a QoS parameter, a mobile device may be capable of determining a number of neighbor wireless transmitters to be searched (e.g., for acquisition of a PRS, etc.) in a more effective and/or more efficient manner, an order and/or duration of a particular PRS search, dynamic time frame for responding with RSTD measurements, whether greater accuracy or faster time-to-first fix (TTFF) is desired for an optimum or otherwise suitable position fix, or the like. Having measured PRS, a mobile device may perform appropriate RSTD measurements, such as utilizing provided positioning assistance data, for example, and may report RSTD measurements to a location server, such as prior to expiration of a maximum response time specified by the server via a QoS parameter.

In some instances, however, such as if OTDOA is implemented to support positioning operations for smaller, lower-power, resource-constrained, etc. IoT devices, such as Cat-M1 devices, for example, to measure a PRS, a Cat-M1 device may have to transition from an idle state (e.g., a “sleep” mode, etc.) into a connected state (e.g., a “wake” mode, etc.), open a measurement gap typically required for PRS measurements, or the like. In this context, a “measurement gap” is typically a time period during which no signal transmission and reception at a mobile device occurs. Measurement gaps may, for example, be implemented via a mobile device to monitor neighbor wireless transmitters on other frequencies than a serving wireless transmitter (e.g., inter-RAT GSM, 3G, etc.), perform inter-frequency measurements (e.g., RSTD, etc.), or the like. For example, since there is no signal transmission and reception during a measurement gap, a mobile device may be capable of switching to a target cell frequency (e.g., a secondary cell frequency, etc.) so as to acquire a PRS and/or perform appropriate RSTD measurements, and then switching back to a current cell frequency (e.g., a serving cell frequency, etc.). Measurement gaps are generally known and need not be described here in greater detail.

As was indicated, at times, transitioning from an idle state into an active state, opening a measurement gap, etc. may unnecessarily expend battery and/or processing resources of certain mobile devices and, as a result, may negatively affect their operating lifetime and/or overall utility. In addition, particular mobile devices, such as Cat-M1 devices, for example, may be configured to communicate with a wireless transmitter (e.g., an eNode B, etc.) in a half-duplex mode where only a transmit or receive path is active at a given time. Thus, as used herein, “half-duplex” mode refers to a mode of communication in which a mobile device transmits a message to a wireless transmitter via an uplink channel that does not overlap in time with a message transmitted by the wireless transmitter to the mobile device in a downlink channel. In this context, a “transmit path” and a “receive path” typically refer to a pathway, channel, sub-channel, etc. over which a corresponding wireless and/or wired transmit or receive signal is carried. Transmit and receive paths are also generally known and need not be described here in greater detail.

Thus, in some instances, to measure a PRS, such as upon receipt of a PRS measurement request, location information request, etc., a mobile device may, for example, need to transition from an idle state (e.g., a “sleep” mode, etc.) into a connected state (e.g., a “wake” mode, etc.), open a measurement gap, etc., which, again, may increase power consumption, reduce operating lifetime of the device, or the like. At times, to address these or like issues, longer sleep duration, such as while a mobile device is in an eMTC mode, for example, may be utilized, at least in part. Namely, in some instances, a receive path of a mobile device may, for example, be configured so as to decode and/or measure PRS signals during an extended discontinuous reception (DRx) cycle, such as while monitoring a physical downlink control channel (PDCCH) and skipping reception of downlink channels for battery-saving purposes. These or like approaches, however, may also have shortcomings, such as increased latency, for example. As another example, since an allocation of a number of Control Channel Elements (CCEs) is given by a PDCCH format, a control region of a subframe is typically a collection of CCEs containing PDCCHs for multiple mobile devices that may be dispersed within a particular geographic area. As such, in some instances, a mobile device may need to monitor a relatively larger area, such as to extract its own control information, for example. Further, since a mobile device is not explicitly informed of a detailed control channel structure, at times, it may blindly attempt to decode an applicable control region, for example, which may impose a substantial burden on mobile device as the control region may be very large. Again, this may lead to increased battery consumption, operational and/or processing cost, reduced performance, or the like. Accordingly, it may be desirable to develop one or more methods, systems, and/or apparatuses that may enhance and/or improve PRS measuring, such as for lower-power, resource-constrained, etc. mobile devices, for example, via more effective and/or more efficient utilization of available resources.

Thus, as will be discussed in greater detail below, in an implementation, in lieu of maintaining a receiver in an idle state during uplink transmissions in a half-duplex mode, a mobile device may, for example, selectively tune its receiver to acquire available PRS for use in one or more positioning operations, such as OTDOA positioning operations, as one possible example. For purposes of explanation, in LTE, a PRS is typically transmitted via a number of pre-defined LTE positioning subframes grouped via several consecutive subframes or so-called sets. A set of consecutive LTE subframes in which a PRS is transmitted is referred to as a PRS positioning occasion. As pointed out above, a mobile device may, for example, obtain positioning assistance data indicating, among other things, timing and frequency channels of locally transmitted PRS positioning occasions. Here, a mobile device operating in a half-duplex mode may, for example, be capable of scheduling its receiver to acquire applicable PRS positioning occasions while transmitting messages in an uplink channel based, at least in part, on positioning assistance data indicative of timing of these positioning occasions. Based, at least in part, on positioning assistance data, a mobile device may, for example, schedule its receiver to acquire PRS positioning occasions while transmitting uplink messages by determining frequency channels on which positioning occasions are to be transmitted and tuning the receiver to the determined frequency channels during times that PRS positioning occasions are expected. This may, for example, advantageously allow a mobile device to more effectively and/or more efficiently utilize its connected state and, as such, reduce or obviate a need to obtain PRS during an idle state, thus, improving power consumption, resource allocation, operating capability, or the like.

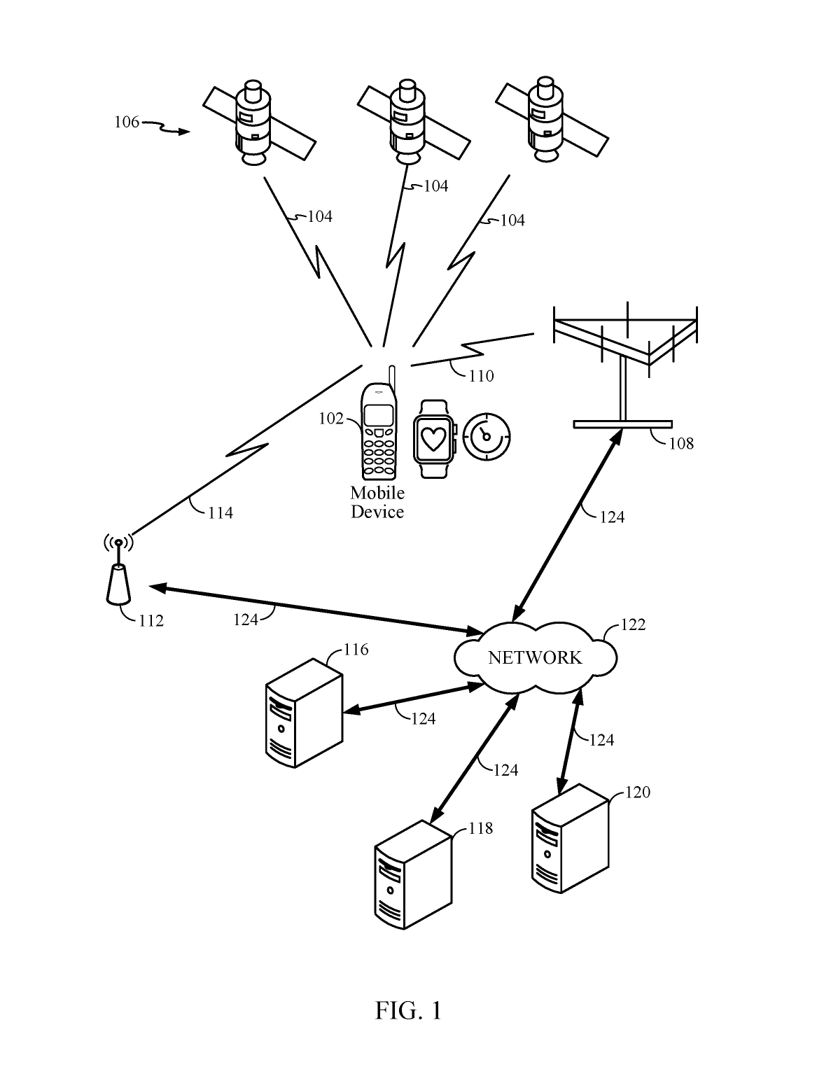

FIG. 1 is a schematic diagram illustrating features associated with an implementation of an example operating environment 100 capable of facilitating and/or supporting one or more processes and/or operations for enhanced resource sharing for PRS measurements for use in or with a mobile device, illustrated generally at 102, which may include an enhanced machine-type communication (eMTC) device, such as a Cat-M1 device, for example. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), WWAN, wireless local area networks (WLAN, etc.), or the like. It should also be noted that claimed subject matter is not limited to indoor implementations. For example, at times, one or more operations and/or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations and/or techniques described herein may be performed, at least in part, in an outdoor environment.

As illustrated, in an implementation, mobile device 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems. In certain implementations, SPS satellites 106 may be from any one several regional navigation satellite systems (RNSS) such as, for example, WAAS, EGNOS, QZSS, just to name a few examples.

At times, mobile device 102 may, for example, transmit wireless signals to, or receive wireless signals from, a suitable wireless communication network. In one example, mobile device 102 may communicate with a cellular communication network, such as by transmitting wireless signals to, or receiving wireless signals from, one or more wireless transmitters capable of transmitting and/or receiving wireless signals, such as a base station transceiver 108 over a wireless communication link 110, for example. Similarly, mobile device 102 may transmit wireless signals to, or receive wireless signals from a local transceiver 112 over a wireless communication link 114. Base station transceiver 108, local transceiver 112, etc. may be of the same or similar type, for example, or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of obtaining one or more observations from one or more other terrestrial transmitters.

In a particular implementation, local transceiver 112 may be capable of communicating with mobile device 102 at a shorter range over wireless communication link 114 than at a range established via base station transceiver 108 over wireless communication link 110. For example, local transceiver 112 may be positioned in an indoor or like environment and may provide access to a wireless local area network (WLAN, e.g., IEEE Std. 802.11 network, etc.) or wireless personal area network (WPAN, e.g., Bluetooth® network, etc.). In another example implementation, local transceiver 112 may comprise a femtocell or picocell capable of facilitating communication via link 114 according to an applicable cellular or like wireless communication protocol. Of course, it should be understood that these are merely examples of networks that may communicate with mobile device 102 over a wireless link, and claimed subject matter is not limited in this respect. For example, in some instances, operating environment 100 may include a larger number of base station transceivers 108, local transceivers 112, etc.

In an implementation, base station transceiver 108, local transceiver 112, etc. may communicate with servers 116, 118, or 120 over a network 122 via one or more links 124. Network 122 may comprise, for example, any combination of wired or wireless communication links. In a particular implementation, network 122 may comprise, for example, Internet Protocol (IP)-type infrastructure capable of facilitating or supporting communication between mobile device 102 and one or more servers 116, 118, 120, etc. via local transceiver 112, base station transceiver 108, etc. In another implementation, network 122 may comprise, for example cellular communication network infrastructure, such as a base station controller or master switching center to facilitate and/or support mobile cellular communication with mobile device 102. As was indicated, in some instances, network 122 may facilitate and/or support communications with a PSAP (not shown) or like entity, such as for purposes of initiating and/or implementing an E911 OTDOA positioning session, for example, if applicable. Servers 116, 118, and/or 120 may comprise any suitable servers or combination thereof capable of facilitating or supporting one or more operations and/or techniques discussed herein. For example, servers 116, 118, and/or 120 may comprise one or more location servers (e.g., Evolved Serving Mobile Location Server (E-SMLC), Secure User Plane Location Server / SUPL Location Platform (SUPL SLP), etc.), positioning assistance servers, navigation servers, map servers, crowdsourcing servers, network-related servers, or the like.

In particular implementations, and as also discussed below, mobile device 102 may have circuitry or processing resources capable of determining a position fix or estimated location of mobile device 102, initial (e.g., a priori) or otherwise. For example, if satellite signals 104 are available, mobile device 102 may compute a position fix based, at least in part, on pseudorange measurements to four or more SPS satellites 106. Here, mobile device 102 may compute such pseudorange measurements based, at least in part, on pseudonoise code phase detections in signals 104 acquired from four or more SPS satellites 106. In particular implementations, mobile device 102 may receive from one or more servers 116, 118, or 120 positioning assistance data to aid in the acquisition of signals 104 transmitted by SPS satellites 106 including, for example, almanac, ephemeris data, Doppler search windows, just to name a few examples.

In some implementations, mobile device 102 may obtain a position fix by processing wireless signals received from one or more terrestrial transmitters positioned at known locations (e.g., base station transceiver 108, local transceiver 112, etc.) using any one of several techniques, such as, for example, OTDOA, AFLT, or the like. In these techniques, a range from mobile device 102 may, for example, be measured to three or more of terrestrial transmitters based, at least in part, on one or more reference signals (e.g., PRS, etc.) transmitted by these transmitters and received at mobile device 102, as was indicated. Here, servers 116, 118, or 120 may be capable of providing positioning assistance data to mobile device 102 including, for example, OTDOA reference transmitter data, OTDOA neighbor transmitter data, RSTD search window, QoS parameters, PRS configuration parameters, candidate or otherwise, locations, identities, orientations, etc. of terrestrial transmitters to facilitate and/or support one or more applicable positioning techniques (e.g., AFLT, OTDOA, etc.). At times, servers 116, 118, or 120 may include, for example, a base station almanac (BSA) indicating locations, identities, orientations, etc. of cellular base stations (e.g., base station transceiver 108, local transceiver 112, etc.) in one or more particular areas or regions associated with operating environment 100.

As alluded to previously, in particular environments, such as indoor or like environments (e.g., urban canyons, etc.), mobile device 102 may not be capable of acquiring and/or processing signals 104 from a sufficient number of SPS satellites 106 so as to perform a suitable positioning technique. Thus, optionally or alternatively, mobile device 102 may be capable of determining a position fix based, at least in part, on signals acquired from one or more local transmitters, such as femtocells, Wi-Fi access points, or the like. For example, mobile device 102 may obtain a position fix by measuring ranges to three or more local transceivers 112 positioned at known locations. In some implementations, mobile device 102 may, for example, measure ranges by obtaining a MAC address from local transceiver 112, as was indicated.

In an implementation, mobile device 102 may, for example, receive positioning assistance data (e.g., OTDOA, AFLT assistance data, etc.) for one or more positioning operations from servers 116, 118, and/or 120. At times, positioning assistance data may include, for example, locations, identities, orientations, PRS configurations, etc. of one or more local transceivers 112, base station transceivers 108, etc. positioned at known locations for measuring ranges to these transmitters based, at least in part, on an RTT, TOA, TDOA, etc., or any combination thereof. In some instances, positioning assistance data to aid indoor positioning operations may include, for example, radio heat maps, context parameter maps, routeability graphs, etc., just to name a few examples. Other assistance data received by mobile device 102 may include, for example, electronic digital maps of indoor or like areas for display or to aid in navigation. A map may be provided to mobile device 102 as it enters a particular area, for example, and may show applicable features such as doors, hallways, entry ways, walls, etc., points of interest, such as bathrooms, pay phones, room names, stores, or the like. By obtaining a digital map of an indoor or like area of interest, mobile device 102 may, for example, be capable of overlaying its current location over the displayed map of the area so as to provide an associated user with additional context, frame of reference, or the like. The terms “positioning assistance data” and “navigation assistance data” may be used interchangeably herein.

According to an implementation, mobile device 102 may access navigation assistance data via servers 116, 118, and/or 120 by, for example, requesting such data through selection of a universal resource locator (URL). In particular implementations, servers 116, 118, and/or 120 may be capable of providing navigation assistance data to cover many different areas including, for example, floors of buildings, wings of hospitals, terminals at an airport, portions of a university campus, areas of a large shopping mall, etc., just to name a few examples. Also, if memory or data transmission resources at mobile device 102 make receipt of positioning assistance data for all areas served by servers 116, 118, and/or 120 impractical or infeasible, a request for such data from mobile device 102 may, for example, indicate a rough or course estimate of a location of mobile device 102. Mobile device 102 may then be provided navigation assistance data covering, for example, one or more areas including or proximate to a roughly estimated location of mobile device 102. In some instances, one or more servers 116, 118, and/or 120 may facilitate and/or support searching for and/or measuring PRS from one or more applicable wireless transmitters (e.g., local transceiver 112, base station transceiver 108, etc.) and/or performing RSTD or like measurements, such as for determining a position fix in connection with an OTDOA or like positioning session, for example, and may provide the position fix to mobile device 102.

Even though a certain number of computing platforms and/or devices are illustrated herein, any number of suitable computing platforms and/or devices may be implemented to facilitate and/or support one or more techniques and/or processes associated with operating environment 100. For example, at times, network 122 may be coupled to one or more wired or wireless communication networks (e.g., WLAN, etc.) so as to enhance a coverage area for communications with mobile device 102, one or more base station transceivers 108, local transceiver 112, servers 116, 118, 120, or the like. In some instances, network 122 may facilitate and/or support femtocell-based operative regions of coverage, for example. Again, these are merely example implementations, and claimed subject matter is not limited in this regard.

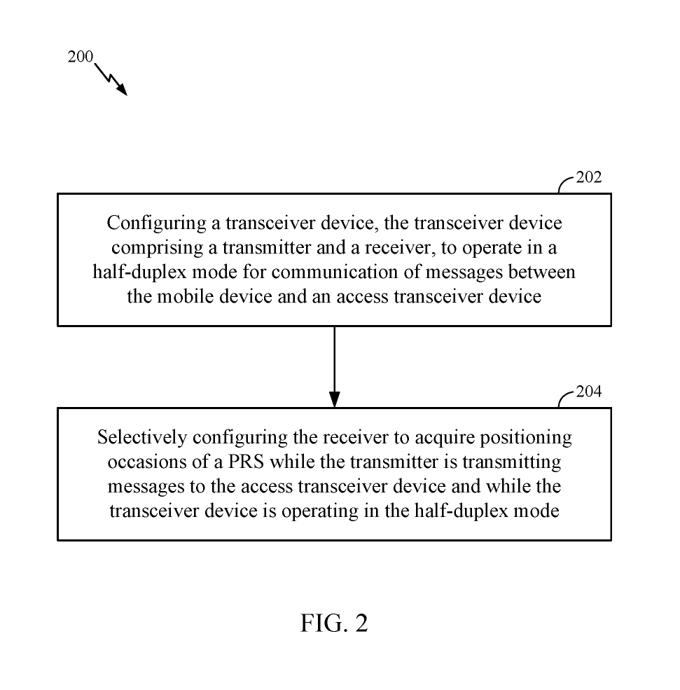

With this in mind, attention is now drawn to FIG. 2, which is a flow diagram illustrating an implementation of an example process 200 that may be performed, in whole or in part, to facilitate and/or support one or more operations and/or techniques for enhanced resource sharing for PRS measurements. As was indicated, at times, process 200 may be implemented, at least in part, via mobile device 102 of FIG. 1, which may comprise, for example, an eMTC Cat-M1 device, though claimed subject matter is not so limited. For example, in some instances, one or more operations of process 200 may be implemented, at least in part, via an LTE NB-IoT device, just to illustrate another possible implementation. At times, one or more operations of process 200 may be implemented, at least in part, via a server device, such as one or more servers 116, 118, and/or 120 of FIG. 1, or any combination of a server device and a mobile device. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects and/or features illustrated in certain other figures, one or more operations may be performed with other aspects and/or features.

It should be noted that, depending on an implementation, process 200 may, for example, be implemented, in whole or in part, in connection with any suitable communication and/or positioning protocol. For example, at times, process 200 may be implemented, at least in part, in connection with OTDOA positioning using a Long Term Evolution (LTE) positioning protocol (LPP), though, again, claimed subject matter is not limited in this regard. In some instances, an LPPe, LPP/LPPe, RRC protocol (e.g., as defined in 3GPP TS 36.331, etc.), IS-801 protocol (e.g., as defined in 3GPP2 TS C.S0022, etc.), or the like may also be employed herein, in whole or in part. Thus, at times, one or more operations and/or techniques for enhanced resource sharing for PRS measurements may, for example, be implemented in connection with OTDOA positioning for UMTS access, Enhanced Observed Time Difference (E-OTD) for GSM or AFLT, or the like. In addition, a downlink signal that is measured by mobile device 202 may not be a PRS, such as currently defined in 3GPP, but some other downlink reference signal or pilot signal (e.g., a common reference signal (CRS) for LTE, etc.). In addition, measurements of a downlink signal may not be of RSTD, such as also defined by 3GPP, for example, but instead of some other suitable quantity and/or phenomena, such as TOA, angle of arrival (AOA), received signal strength (e.g., RSSI), return trip time (RTT), signal-to-noise (S/N) ratio (SNR), or the like. Thus, although one or more applicable positioning techniques, protocols, measured quantities, etc. may differ, a search strategy with respect to acquisition of one or more downlink reference signals and/or pilot signals, such as via an enhanced resource sharing, as discussed herein, for example, may be the same as or similar to that described for process 200.

Thus, example process 200 may, for example, begin at operation 202 with configuring a transceiver device, the transceiver device comprising a transmitter and a receiver, to operate in a half-duplex mode for communication of messages between the mobile device and an access transceiver device. For example, as was indicated, in some instances, a transceiver device of a particular mobile device may be configured for processing LTE signals, such as PRS, as one possible example, so as to facilitate and/or support OTDOA positioning. At times, a transceiver device may, for example, be configured, at least in part, to support lower data-rate applications, such as while coexisting with currently deployed (e.g., legacy, etc.) LTE infrastructure, spectrum, and/or devices. By way of example but not limitation, in some instances, a particular configuration of a transceiver device may be at least partially defined via the eMTC standard, which provides for delivering data rates up to 1 Mbps, while utilizing 1.4 MHz device bandwidth (e.g., 1.08 MHz in-band transmissions of 6 resource blocks, etc.) in existing LTE frequency division duplex (FDD) and/or time division duplex (TDD) spectrum. Thus, a particular transceiver device may, for example, be at least partially configured to process regular LTE traffic (e.g., Cat-0 and above, etc.), support voice LTE (VoLTE), full-to-limited mobility, deliver 15 dB of increased link budget, operate within an LTE carrier environment of up to a 20 MHz operational bandwidth, etc. Of course, claimed subject matter is not so limited.

At times, a transceiver device may, for example, be configured, at least in part, to utilize its associated transmit and receive paths independently and/or separately from each other. For example, a transceiver device may comprise different antenna ports, physical antennas, voltage controlled oscillators (VCOs), etc. that may be employed separately for a particular communication path. As discussed below, in some instances, distinct transmit and receive communication paths may, for example, be employed, at least in part, to facilitate and/or support one or more operations and/or techniques for enhanced resource sharing for PRS measurements. As was also indicated, in some instances, a transceiver device may, for example, be configured to operate in a half-duplex mode in which only a transmit or receive path is active at a given time. For example, a transceiver device may be configured to support a half-duplex FDD mode, half-duplex TDD mode, or any combination thereof, which may depend, at least in part, on a particular mobile device, technology, communication protocol, application, or the like.

Further, communication of messages between a mobile device and access transceiver device may, for example, be implemented according to any suitable communication protocol. For example, depending on an implementation, one or more messages between a mobile device and access transceiver device may be communicated according to an LTE positioning protocol (LPP), an LPP extensions (LPPe) protocol, a Secure User Plane Location (SUPL) user plane location protocol (ULP), a Location Services Application Protocol (LCS-AP) control plane protocol, or the like, or any combination thereof. An access transceiver device may comprise, for example, any suitable wireless transmitter capable of transmitting and/or receiving wireless signals. For example, an access transceiver device may comprise a serving cellular base station, a serving wireless local area network (WLAN) access point, or the like. It should be noted that these are merely examples relating to a particular transceiver device, communication protocols, modes, configurations, etc., and that claimed subject matter is not limited in this regard.

With regard to operation 204, the receiver may, for example, be selectively configured to acquire positioning occasions of a PRS while the transmitter is transmitting messages to the access transceiver device in an uplink and while the transceiver device is operating in the half-duplex mode. For example, as was indicated, positioning assistance data comprising, among other things, timing and frequency channels of locally transmitted PRS positioning occasions may be provided to a mobile device, such as via a suitable server. Here, a receiver of a mobile device operating in a half-duplex mode may, for example, be selectively configured to acquire PRS positioning occasions while transmitting messages in an uplink channel based, at least in part, on such assistance data. Given that PRS transmissions are typically periodic and, as such, known to a mobile device, such as a priori and/or after an initial transmission, a receive chain may, for example, be appropriately configured prior to a required sub-frame time.

More specifically, in some instances, such as after an initial hand-shake with an access transceiver device, for example, a mobile device may continually transmit data in an uplink for n configured repetitions. In turn, no data is typically expected to be received from an access transceiver device on a downlink for this duration. Since, at times, repetition factors may be as high as 2048 (e.g., for mode B, etc.), a receive path of a mobile device may, for example, be available for at least this duration, and, as such, may be utilized independently. By way of example but not limitation, if number of repetitions comprises 192, for example, a receive path may be selectively configured for an independent activity (e.g., to acquire positioning occasions of a PRS, etc.) for 192 milliseconds. Thus, here, a mobile device may schedule its receiver to acquire PRS positioning occasions while transmitting uplink messages by determining frequency channels on which positioning occasions are to be transmitted, for example, and/or tuning the receiver to the determined frequency channels during times that positioning occasions are expected. As another illustration, if a mobile device is performing uplink transmit repetitions for 64 sub-frames, for example, based, at least in part, on a determined periodicity, a mobile device may schedule its receiver to acquire PRS occasions during such a transmit activity (e.g., 35th sub-frame, etc.). Claimed subject matter is not so limited, of course.

Depending on an implementation, a mobile device may or may not be configured with a transmit/receive (Tx/Rx) filter that allows the mobile device to simultaneously transmit and receive messages at any available transmit and receive channel without desensing acquisition of signals at a receiver. In this context, “desensing” or “desensitizing” refers to a phenomenon in which a relatively stronger signal from a transmitter impacts a concurrent detection and/or acquisition of a relatively weaker signal by a receiver due, at least in part, to electromagnetic interference (EMI). Desensing may, for example, be a result of close physical proximity of transmitter and receiver antennas and/or paths, close transmitter and receiver frequencies, higher power output from a transmitter, or the like. Desensing may lead to signal distortion, loss of signal range, partial or complete loss of signal, or the like. Desensing as well as Tx/Rx filters are also generally known and need not be described here in greater detail.

Thus, in a particular implementation, such as in which a mobile device is configured with a TX/RX filter and operates in a half-duplex mode, for example, an associated receiver may be selectively configured to acquire PRS positioning occasions by tuning the receiver to acquire the occasions in one or more downlink frequency channels. Here, due, at least in part, to a TX/RX filter, these channels may, for example, be selected irrespective of a particular frequency channel on which a mobile device is transmitting uplink messages. As such, a receive path of an associated transceiver device may, for example, be advantageously utilized, at least in part, for all available frequencies (e.g., per obtained positioning assistance data, etc.), such as without impacting or otherwise negatively affecting ongoing transmitter activity.

In some instances, such as if there is no TX/RX filter present, however, a mobile device may, for example, be configured instead to tune its receiver to acquire PRS positioning occasions in one or more frequency channels that are not impacted or desensed by concurrent transmission of messages in one or more uplink frequency channels. As such, a receive chain may, for example, be used, at least in part, to acquire PRS positioning occasions from neighbor wireless transmitters with least expected desense due to ongoing transmitter activity. Here, neighbor wireless transmitters obtained via positioning assistance data may, for example, be prioritized accordingly, such as to minimize desense. To facilitate and/or support this, at times, positioning assistance data comprising neighbor cell information for different bands may, for example, be correlated with current transmitter activity to determine appropriate receiver frequencies, such that desense is below or above a receiver desense threshold. A receiver desense threshold may be determined, at least in part, experimentally and may be pre-defined or configured, for example, or otherwise dynamically defined in some manner depending on a particular wireless environment, mobile device, transceiver device, application, or the like. A receiver desense threshold may, for example, be based, at least in part, on signal strength (SS), signal-to-noise ratio (SNR), transmit and/or receive band of operation, or the like.

By way of example but not limitation, a particular transceiver device with a frequency of 710 MHz in an uplink may have a 3rd harmonic desense for Band 1 or 2130 MHz in a downlink, meaning that desense will typically not be seen for Band 5 or 880 MHz in a downlink. This approach may be extended to scenarios in which transmit and receive channels belong to the same band but spaced far enough, such that an adjacent channel leakage ratio (ACLR) impact is minimum or otherwise suitable. At times, it may also be useful to generate and/or employ a look up table comprising supported bands of operation and having corresponding desense characterizations. Such a table may, for example, be stored in a local memory of a mobile device, and may be accessed and/or employed to prioritize acquisitions of PRS positioning occasions from neighbor wireless transmitters obtained via positioning assistance data, as was also indicated.

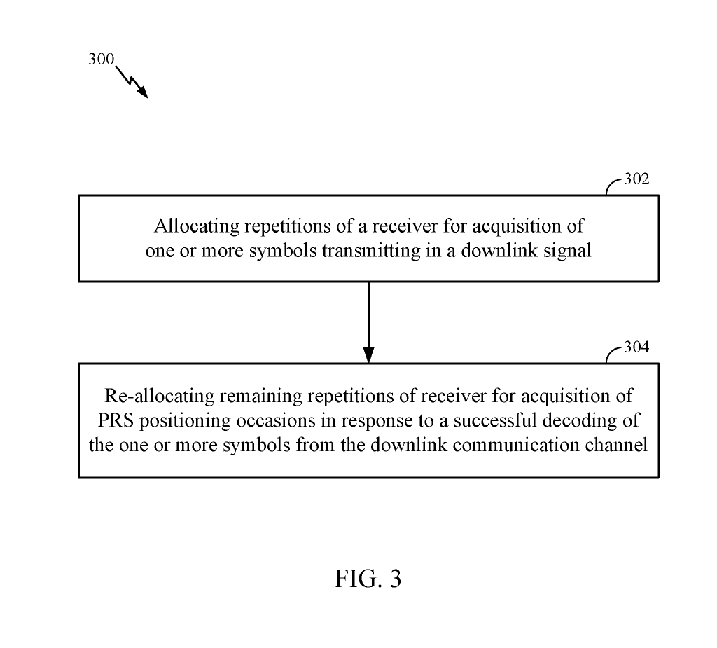

Attention is now drawn to FIG. 3, which is a flow diagram illustrating an implementation of another example process, referenced herein at 300, that may be performed, in whole or in part, to facilitate and/or support one or more operations and/or techniques for enhanced resource sharing for PRS measurements. Likewise, at times, process 300 may be implemented, at least in part, via mobile device 102 of FIG. 1, which may comprise, for example, an eMTC Cat-M1 device, though claimed subject matter is not so limited. For example, in some instances, one or more operations of process 300 may be implemented, at least in part, via an LTE NB-IoT device, just to illustrate another possible implementation. At times, one or more operations of process 300 may be implemented, at least in part, via a server device, such as one or more servers 116, 118, and/or 120 of FIG. 1, or any combination of a server device and a mobile device. Similarly, it should be noted that information acquired or produced, such as, for example, input signals, output signals, operations, results, etc. associated with example process 300 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Thus, example process 300 may, for example, begin at operation 302 with allocating repetitions of a receiver for acquisition of one or more symbols transmitting in a downlink signal. For example, for a mobile device to successfully “camp” on a desired access transceiver device, the mobile device may need to decode one or more particular symbols repeatedly transmitted in a downlink channel, such as a master information block (MIB) symbol in a physical broadcast channel (PBCH), for example. In this context, “camping” refers to a state of connectivity of a mobile device in which the mobile device is connected and/or tuned to a particular wireless transmitter's control channel, such as for the purposes of area registration, obtaining available wireless services, messaging, or the like. Thus, a time period to receive a particular number of “repetitions” of a repeatedly transmitted particular symbol may, for example, be allocated for decoding the particular symbol. In some instances, such repetitions may be allocated, for example, in a handshake operation between a mobile device and an access transceiver device (e.g., eNode B, etc.), such as while the mobile device is trying to “camp” on the access transceiver device, as was indicated.

With regard to operation 304, remaining repetitions of a receiver may, for example, be re-allocated for acquisition of PRS positioning occasions in response to a successful decoding of the one or more symbols from the downlink communication channel. Namely, if a mobile device is able to successfully and/or reliably decode a particular symbol repeatedly transmitted prior to exhaustion of receiver time allocated to acquiring the repeatedly transmitted symbol, such as at operation 302, for example, the mobile device may re-allocate remaining receiving time of a receiver for acquisition of PRS positioning occasions. For example, a mobile device may tune its receiver to acquire one or more locally transmitted PRS positioning occasions via one or more techniques discussed above. To illustrate, if a number of repetitions determined via an initial assessment (e.g., in a handshake, etc.) is 16, for example, and a mobile device is able to successfully decode PBCH in 8 repetitions, then the remaining 8 milliseconds of corresponding repetitions may be used to complete any other suitable activity, such as acquire PRS positioning occasions. Claimed subject matter is not limited to a particular example, of course.

Accordingly, as discussed herein, enhanced resource sharing for PRS measurements may provide benefits. For example, given that a receiver may be independently configured, a receiver chain may be capable of decoding a PRS measurement request and/or location information request with little or no impact on an ongoing transceiver activity. As was indicated, at times, a number of repetitions may be as high as 2048 (e.g., about 2.0 seconds), which, in some instances, may provide an opportunity to independently use a receive path for a significant or otherwise sufficient duration of time. Given LTE sub-frame configurations, a time available for an independent configuration of either a transmit or receive path may comprise, for example, 2.0 milliseconds, meaning that a receiver may be advantageously “borrowed” for 2 consecutive uplink slots. In addition, a mobile device may be capable of utilizing available resources more effectively and/or more efficiently, such as while in an eMTC mode, for example, and in parallel may also be capable of decoding a PRS without having to transition from an idle state (e.g., a “sleep” mode, etc.) into a connected state (e.g., a “wake” mode, etc.) and/or opening a measurement gap, among other things. Of course, such a description of certain aspects of enhanced resource sharing for PRS measurements and its benefits is merely an example, and claimed subject matter is not so limited.

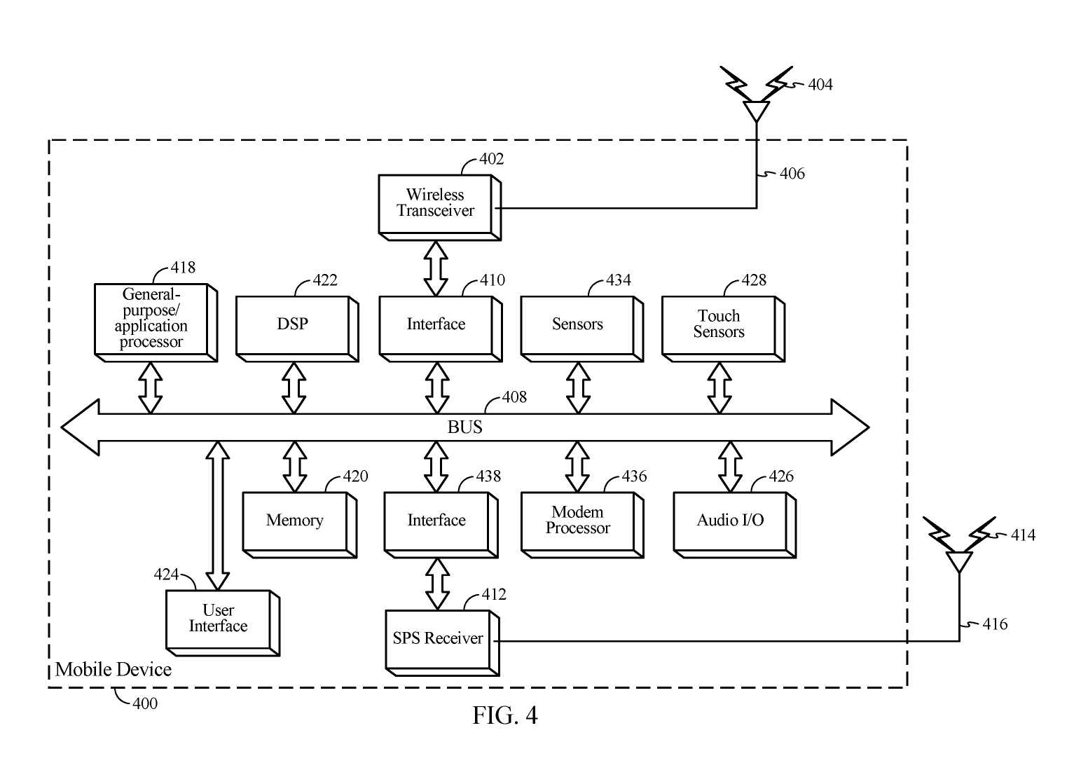

FIG. 4 is a schematic diagram of an implementation of an example computing environment associated with a mobile device that may be used, at least in part, to facilitate or support one or more operations and/or techniques for enhanced resource sharing for PRS measurements. An example computing environment may comprise, for example, a mobile device 400 that may include one or more features or aspects of mobile device 102 of FIG. 1, though claimed subject matter is not so limited. For example, in some instances, mobile device 400 may comprise a wireless transceiver 402 capable of transmitting and/or receiving wireless signals, referenced generally at 404, such as via an antenna 406 over a suitable wireless communications network. Wireless transceiver 402 may, for example, be capable of sending or receiving one or more suitable communications, such as one or more communications discussed with reference to FIGS. 1-3. Wireless transceiver 402 may, for example, be coupled or connected to a bus 408 via a wireless transceiver bus interface 410. Depending on an implementation, at times, wireless transceiver bus interface 410 may, for example, be at least partially integrated with wireless transceiver 402. Some implementations may include multiple wireless transceivers 402 or antennas 406 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 400 may, for example, comprise an SPS or like receiver 412 capable of receiving or acquiring one or more SPS or other suitable wireless signals 414, such as via an SPS or like antenna 416. SPS receiver 412 may process, in whole or in part, one or more acquired SPS signals 414 for estimating a location of mobile device 400, initial or otherwise. In some instances, one or more general-purpose/application processors 418 (henceforth referred to as “processor”), memory 420, digital signal processor(s) (DSP) 422, or like specialized devices or processors not shown may be utilized to process acquired SPS signals 414, in whole or in part, calculate a location of mobile device 400, such as in conjunction with SPS receiver 412, or the like. Storage of SPS or other signals for implementing one or more positioning operations, such as in connection with one or more techniques for enhanced passive positioning with adaptive active positioning, for example, may be performed, at least in part, in memory 420, suitable registers or buffers (not shown). It should be appreciated that in at least one implementation one or more processors 418 may comprise one or more location processing modules capable of obtaining a first estimated location of mobile device 400 based, at least in part, on the passive measurements and in absence of active measurements; and initiating the active measurements for obtaining a second estimated location of mobile device 400 in response to determining that the first estimated location is not of sufficient quality based, at least in part, on the first estimated location and a spatial configuration of the terrestrial transmitters. In certain implementations, another processor, such as DSP 422, for example, may comprise a separate processing module that may be utilized, at least in part, to initiate active measurements, such as via processing and/or communicating one or more digital signals representative of the active measurements, for example, to obtain a second estimated location of mobile device 400 in response to a determination that the first estimated location is not of sufficient quality based, at least in part, on the first estimated location and a spatial configuration of the terrestrial transmitters.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 418 or DSP 422 may include one or more processors, controllers, microprocessors, microcontrollers, application specific integrated circuits, digital signal processors, programmable logic devices, field programmable gate arrays, central processing units, graphics processor units, or the like, or any combination thereof. Thus, at times, processor 418 or DSP 422 or any combination thereof may comprise or be representative of means for means for configuring a transceiver device, the transceiver device comprising a transmitter and a receiver, to operate in a half-duplex mode for communication of messages between a mobile device and an access transceiver device, such as to implement operation 202 of FIG. 2, at least in part. In addition, in at least one implementation, processor 418 or DSP 422 may be representative of or comprise, for example, means for selectively configuring the receiver to acquire positioning occasions of a PRS while the transmitter is transmitting messages to the access transceiver device in an uplink and while the transceiver device is operating in the half-duplex mode, such as to implement operation 204 of FIG. 2, at least in part.

As illustrated, DSP 422 may be coupled or connected to processor 418 and memory 420 via bus 408. Although not shown, in some instances, bus 408 may comprise one or more bus interfaces that may be integrated with one or more applicable components of mobile device 400, such as DSP 422, processor 418, memory 420, or the like. In various embodiments, one or more operations or functions described herein may be performed in response to execution of one or more machine-readable instructions stored in memory 420, such as on a computer-readable storage medium, such as RAM, ROM, FLASH, disc drive, etc., just to name a few examples. Instructions may, for example, be executable via processor 418, one or more specialized processors not shown, DSP 422, or the like. Memory 420 may comprise a non-transitory processor-readable memory, computer-readable memory, etc. that may store software code (e.g., programming code, instructions, etc.) that may be executable by processor 418, DSP 422, or the like to perform operations or functions described herein.

Mobile device 400 may comprise a user interface 424, which may include any one of several devices such as, for example, a speaker, microphone, display device, vibration device, keyboard, touch screen, etc., just to name a few examples. In at least one implementation, user interface 424 may enable a user to interact with one or more applications hosted on mobile device 400. For example, one or more devices of user interface 424 may store analog or digital signals on memory 420 to be further processed by DSP 422, processor 418, etc. in response to input or action from a user. Similarly, one or more applications hosted on mobile device 400 may store analog or digital signals in memory 420 to present an output signal to a user. In some implementations, mobile device 400 may optionally include a dedicated audio input/output (I/O) device 426 comprising, for example, a dedicated speaker, microphone, digital to analog circuitry, analog to digital circuitry, amplifiers, gain control, or the like. It should be understood, however, that this is merely an example of how audio I/O device 426 may be implemented, and that claimed subject matter is not limited in this respect. As seen, mobile device 400 may comprise one or more touch sensors 428 responsive to touching or like pressure applied on a keyboard, touch screen, or the like.

Mobile device 400 may comprise one or more sensors 434 coupled or connected to bus 408, such as, for example, one or more inertial sensors, ambient environment sensors, or the like. Inertial sensors of sensors 434 may comprise, for example, one or more accelerometers (e.g., collectively responding to acceleration of mobile device 400 in one, two, or three dimensions, etc.), gyroscopes or magnetometers (e.g., to support one or more compass or like applications, etc.), etc., just to illustrate a few examples. Ambient environment sensors of mobile device 400 may comprise, for example, one or more barometric pressure sensors, temperature sensors, ambient light detectors, camera sensors, microphones, etc., just to name few examples. Sensors 434 may generate analog or digital signals that may be stored in memory 420 and may be processed by DSP 422, processor 418, etc., such as in support of one or more applications directed to positioning or navigation operations, wireless communications, radio heat map learning, video gaming or the like.

In a particular implementation, mobile device 400 may comprise, for example, a modem processor 436, dedicated or otherwise, capable of performing baseband processing of signals received or downconverted via wireless transceiver 402, SPS receiver 412, or the like. Similarly, modem processor 436 may perform baseband processing of signals to be upconverted for transmission via wireless transceiver 402, for example. In alternative implementations, instead of having a dedicated modem processor, baseband processing may be performed, at least in part, by processor 418, DSP 422, or the like. In addition, in some instances, an interface 438, although illustrated as a separate component, may be integrated, in whole or in part, with one or more applicable components of mobile device 400, such as bus 408 or SPS receiver 412, for example. Optionally or alternatively, SPS receiver 412 may be coupled or connected to bus 408 directly. It should be understood, however, that these are merely examples of components or structures that may perform baseband processing, and that claimed subject matter is not limited in this regard.

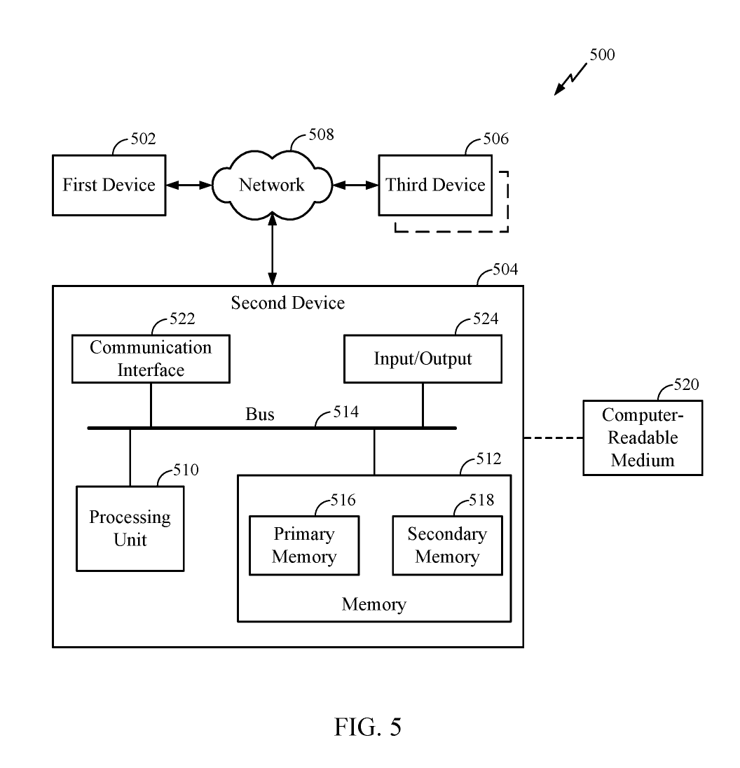

FIG. 5 is a schematic diagram illustrating an implementation of an example computing environment or system 500 that may be associated with or include one or more servers or other devices capable of partially or substantially implementing or supporting one or more operations and/or techniques for enhanced resource sharing for PRS measurements, such as discussed above in connection with FIGS. 1-3, for example. Computing environment 500 may include, for example, a first device 502, a second device 504, a third device 506, etc., which may be operatively coupled together via a communications network 508. In some instances, first device 502 may comprise a server capable of providing positioning assistance parameters, such as, for example, identities, locations, etc. of known wireless transmitters, radio heat map, base station almanac, electronic digital map, database of wireless transmitters, bias estimates, signal measurements, or the like. For example, first device 502 may also comprise a server capable of providing an electronic digital map to a mobile device based, at least in part, on a coarse or rough estimate of a location of the mobile device, upon request, or the like. First device 502 may also comprise a server capable of providing any other suitable positioning assistance parameters (e.g., an electronic digital map, radio heat map, etc.), relevant to a location of a mobile device. Second device 504 or third device 506 may comprise, for example, mobile devices, though claimed subject matter is not so limited. For example, in some instances, second device 504 may comprise a server functionally or structurally similar to first device 502, just to illustrate another possible implementation. In addition, communications network 508 may comprise, for example, one or more wireless transmitters, such as access points, femtocells, or the like. Of course, claimed subject matter is not limited in scope in these respects.

First device 502, second device 504, or third device 506 may be representative of any device, appliance, platform, or machine that may be capable of exchanging parameters and/or information over communications network 508. By way of example but not limitation, any of first device 502, second device 504, or third device 506 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 502, 504, and 506, respectively, may comprise one or more of a mobile device, wireless transmitter or receiver, server, etc. in accordance with example implementations described herein.

In an implementation, communications network 508 may be representative of one or more communication links, processes, or resources capable of supporting an exchange of information between at least two of first device 502, second device 504, or third device 506. By way of example but not limitation, communications network 508 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 506, there may be additional like devices operatively coupled to communications network 508. It is also recognized that all or part of various devices or networks shown in computing environment 500, or processes or methods, as described herein, may be implemented using or otherwise including hardware, firmware, software, or any combination thereof.

By way of example but not limitation, second device 504 may include at least one processing unit 510 that may be operatively coupled to a memory 512 via a bus 514. Processing unit 510 may be representative of one or more circuits capable of performing at least a portion of a suitable computing procedure or process. For example, processing unit 510 may include one or more processors, controllers, microprocessors, microcontrollers, application specific integrated circuits, digital signal processors, programmable logic devices, field programmable gate arrays, or the like, or any combination thereof. Although not shown, second device 504 may include a location-tracking unit that may initiate a position fix of a suitable mobile device, such as in an area of interest, for example, based, at least in part, on one or more received or acquired wireless signals, such as from an SPS, one or more WLAN access points, etc. In some implementations, a location-tracking unit may be at least partially integrated with a suitable processing unit, such as processing unit 510, for example, though claimed subject matter is not so limited. In certain server-based or server-supported implementations, processing unit 510 may, for example, comprise means for configuring a transceiver device, the transceiver device comprising a transmitter and a receiver, to operate in a half-duplex mode for communication of messages between a mobile device and an access transceiver device, such as to facilitate or support operations 202 and/or 204 of FIG. 2, at least in part. In some instances, processing unit 510 may, for example, comprise means for selectively configuring the receiver to acquire positioning occasions of a PRS while the transmitter is transmitting messages to the access transceiver device in an uplink and while the transceiver device is operating in the half-duplex mode, such as to facilitate or support operations 202 and/or 204 of FIG. 2, at least in part.

Memory 512 may be representative of any information storage mechanism or appliance. Memory 512 may include, for example, a primary memory 516 and a secondary memory 518. Primary memory 516 may include, for example, a random access memory, read only memory, etc. While illustrated in this example as being separate from processing unit 510, it should be understood that all or part of primary memory 516 may be provided within or otherwise co-located/coupled with processing unit 510. Secondary memory 518 may include, for example, same or similar type of memory as primary memory or one or more information storage devices or systems, such as, for example, a disk drive, an optical disc drive, a tape drive, a solid state memory drive, etc. In certain implementations, secondary memory 518 may be operatively receptive of, or otherwise configurable to couple to, a computer-readable medium 520. Computer-readable medium 520 may include, for example, any non-transitory storage medium that may carry or make accessible information, code, or instructions for one or more of devices in computing environment 500. Computer-readable medium 520 may also be referred to as a machine-readable medium, storage medium, or the like.

Second device 504 may include, for example, a communication interface 522 that may provide for or otherwise support an operative coupling of second device 504 to at least communications network 508. By way of example but not limitation, communication interface 522 may include a network interface device or card, a modem, a router, a switch, a transceiver, and the like. Second device 504 may also include, for example, an input/output device 524. Input/output device 524 may be representative of one or more devices or features that may be configurable to accept or otherwise introduce human or machine inputs, or one or more devices or features that may be capable of delivering or otherwise providing for human or machine outputs. By way of example but not limitation, input/output device 524 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays

(“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access

(“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies

(“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method, at a mobile device, comprising:
configuring a transceiver device, the transceiver device comprising a transmitter and a receiver, to operate in a half-duplex mode for communication of messages between the mobile device and an access transceiver device; and
selectively configuring the receiver to acquire positioning occasions of a positioning reference signal (PRS) while the transmitter is transmitting messages to the access transceiver device and while the transceiver device is operating in the half-duplex mode.

2. The method of claim 1, and further comprising:
detecting an absence of a transmit/receive (TX/RX) filter at the mobile device; and
selectively tuning the receiver to acquire positioning occasions of the PRS in one or more particular frequency channels that are not desensed by transmission of messages.

3. The method of claim 1, wherein selectively configuring the receiver to acquire the positioning occasions further comprises scheduling the receiver based, at least in part, on assistance data indicative of timing of the positioning occasions.

4. The method of claim 3, wherein the scheduling the receiver comprises:
determining frequency channels on which positioning occasions are to be transmitted based, at least in part, on the assistance data; and
tuning the receiver to the determined frequency channels during times that positioning occasions are expected.

5. The method of claim 1, wherein the transmitter is configured to transmit messages in during the half-duplex mode.

6. The method of claim 1, wherein selectively configuring the receiver to acquire positioning occasions further comprises tuning the receiver to acquire positioning occasions in one or more downlink frequency channels that are not desensed by transmission of messages.

7. The method of claim 1, wherein the half-duplex mode comprises: a half-duplex frequency division duplex (FDD) mode,or a half-duplex time division duplex (TDD) mode, or a combination thereof.

8. The method of claim 1, wherein the mobile device comprises an Internet of Things (IoT) device.

9. The method of claim 8, wherein the IoT device comprises an enhanced machine-type communications (eMTC) device.

10. The method of claim 9, wherein eMTC device comprises a machine-type category M1 (Cat-M1) device.

11. The method of claim 1, wherein the access transceiver device comprises a serving cellular base station or a serving wireless local area network (WLAN) access point.

12. The method of claim 1, wherein the positioning occasions of the PRS are acquired in connection with performing one or more observed time difference of arrival (OTDOA) measurements.

13. The method of claim 1, wherein the messages between the mobile device and the access transceiver device are communicated according to at least one of: an LTE positioning protocol (LPP); an LPP extensions (LPPe) protocol; a Secure User Plane Location (SUPL) user plane location protocol (ULP); a Location Services Application Protocol (LCS-AP) control plane protocol, or any combination thereof.

14. An apparatus comprising:
means for configuring a transceiver device, the transceiver device comprising a transmitter and a receiver, to operate in a half-duplex mode for communication of messages between a mobile device and an access transceiver device; and
means for selectively configuring the receiver to acquire positioning occasions of a positioning reference signal (PRS) while the transmitter is transmitting messages to the access transceiver device in and while the transceiver device is operating in the half-duplex mode.

15. The apparatus of claim 14, and further comprising:
means for detecting an absence of a TX/RX filter at the mobile device; and
means for selectively tuning the receiver to acquire positioning occasions of the PRS in one or more particular frequency channels that are not desensed by transmission of messages.

16. The apparatus of claim 14, wherein means for selectively configuring the receiver to acquire the positioning occasions further comprises means for scheduling the receiver based, at least in part, on assistance data indicative of timing of the positioning occasions.

17. An apparatus comprising:
a communication interface coupled to a receiver of a mobile device to communicate with an electronic communications network and one or more processors coupled to a memory and to the communication interface, the communication interface and the one or more processors configured to:
configure a transceiver device, the transceiver device comprising a transmitter and a receiver, to operate in a half-duplex mode for communication of messages between the mobile device and an access transceiver device; and
selectively configure the receiver to acquire positioning occasions of a positioning reference signal (PRS) while the transmitter is transmitting messages to the access transceiver device and while the transceiver device is operating in the half-duplex mode.

18. The apparatus of claim 17, wherein the one or more processors further configured to:
detect an absence of a TX/RX filter at the mobile device; and
selectively tune the receiver to acquire positioning occasions of the PRS in one or more particular frequency channels that are not desensed by transmission of messages.

19. The apparatus of claim 17, wherein the one or more processors configured to selectively configure the receiver to acquire the positioning occasions further configured to schedule the receiver based, at least in part, on assistance data indicative of timing of the positioning occasions.

20. The apparatus of claim 19, wherein the one or more processors configured to schedule the receiver further configured to:
determine frequency channels on which positioning occasions are to be transmitted based, at least in part, on the assistance data; and
tune the receiver to the determined frequency channels during times that positioning occasions are expected.

21. The apparatus of claim 17, wherein the transmitter is configured to transmit messages during the half-duplex mode.

22. The apparatus of claim 17, wherein the one or more processors configured to selectively configure the receiver to acquire positioning occasions further configured to tune the receiver to acquire positioning occasions in one or more downlink frequency channels that are not desensed by transmission of messages.

23. The apparatus of claim 17, wherein the half-duplex mode comprises: a half-duplex frequency division duplex (FDD) mode, or a half-duplex time division duplex (TDD) mode, or a combination thereof.

24. The apparatus of claim 17, wherein the mobile device comprises an IoT device.

25. The apparatus of claim 24, wherein the IoT device comprises an enhanced machine-type communications (eMTC) device.

26. The apparatus of claim 25, wherein eMTC device comprises a machine-type category M1 (Cat-M1) device.

27. A non-transitory storage medium having instructions executable by a processor to:
configure a transceiver device, the transceiver device comprising a transmitter and a receiver, to operate in a half-duplex mode for communication of messages between a mobile device and an access transceiver device; and
selectively configure the receiver to acquire positioning occasions of a positioning reference signal (PRS) while the transmitter is transmitting messages to the access transceiver device and while the transceiver device is operating in the half-duplex mode.

28. The non-transitory storage medium of claim 27, wherein the instructions executable by the processor further comprise instructions to:
detect an absence of a TX/RX filter at the mobile device; and
selectively tune the receiver to acquire positioning occasions of the PRS in one or more particular frequency channels that are not desensed by transmission of messages.

29. The non-transitory storage medium of claim 27, wherein the instructions to selectively configure the receiver to acquire the positioning occasions further comprise instructions to schedule the receiver based, at least in part, on assistance data indicative of timing of the positioning occasions.

30. The non-transitory storage medium of claim 29, wherein the instructions to schedule the receiver further comprise instructions to:
determine frequency channels on which positioning occasions are to be transmitted based, at least in part, on the assistance data; and
tune the receiver to the determined frequency channels during times that positioning occasions are expected.
